(19) United States
(12) Patent Application Publication
(10) Pub. No.: US 2005/0207817 A1
(43) Pub. Date: Sep. 22, 2005

(54) Computer keyboard

(76) Inventor: Karla R. Jenkins, East Mckeesport, PA (US)

Correspondence Address: Richard C. Litman;LITMAN LAW OFFICES, LTD., P.O. BOX 15035, Arlington, VA, 22215, US

(21) Appl. No.: 10/801,581

(22) Filed: Mar. 17, 2004

(51) Int. Cl. B41J 5/10

(52) U.S. Cl. 400/489; 400/472

(57) ABSTRACT

A computer keyboard comprises a typewriter section containing lettered keys corresponding to letters of an alphabet. The lettered keys are positioned in a standard order, but are of non-uniform size with respect to one another.

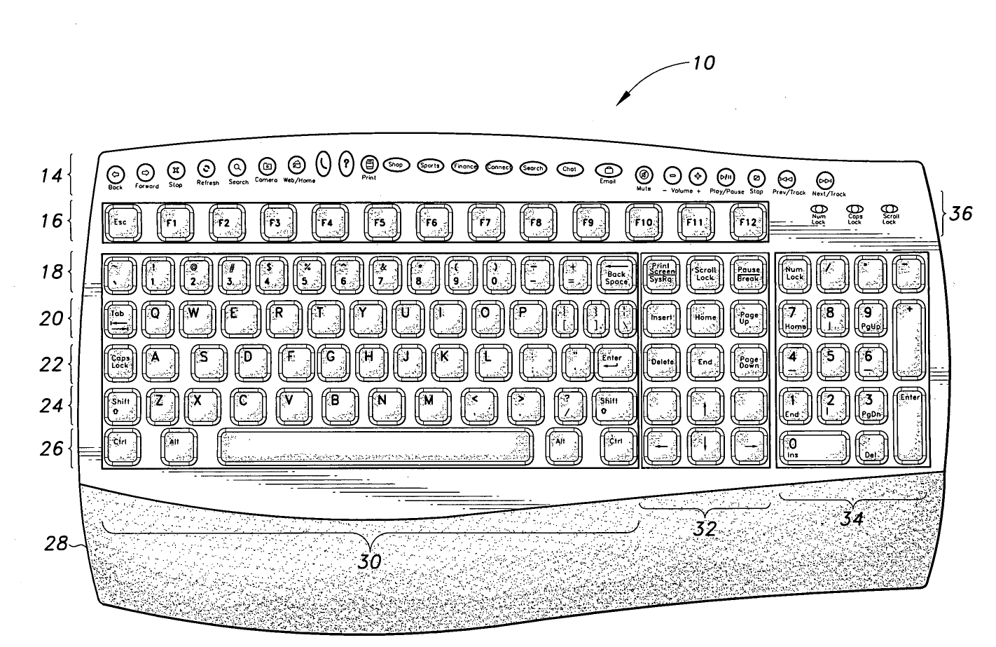

### BACKGROUND OF THE INVENTION

1. Field of the Invention

The present invention relates to computer keyboards. In particular, the present invention relates to a computer keyboard for individuals with large or indexterous hands.

2. Description of the Related Art

Computer keyboards are used to input text, commands, and other information into computers. As such, the typical keyboard consists of a platform supporting a number of push buttons, each designating a letter, number, symbol, command, or other information. The most common computer keyboard layout in the United States and most English speaking countries is known as QWERTY, so called because first six letters of the top row of letters at the left spell out “QWERTY”. This layout was established in the early days of mechanical typewriters. Other layouts are known, among them most notably is “Dvorak”, which is designed to provide a more efficient layout than QWERTY.

It has perhaps not heretofore been recognized that, for many individuals, standard keyboards, regardless of the key layout, have keys that are too small and too close together. These individuals may find it difficult to consistently press the intended key without also pressing a neighboring key. Such individuals may have larger-than-average hand size, thick fingers, or stiffness in the hand.

It is known to provide keyboards in different sizes. For example, one on-line provider, “www.KidsToyChest.com” makes available a “Big Key Keyboard”, which has “large, colorful, easy to read keys”, and a “Little Fingers Keyboard” that is essentially a downsized version of a fully-functioning computer keyboard. U.S. Design Pat. No. D-420,997, issued Feb. 22, 2000 to Jordan, is another example of a “child sized computer keyboard.”

Another on-line provider, “www.EnableMart.com” sells a “BigKeys LX” keyboard with either a QWERTY layout, or an “ABC” layout, in which the keys are arranged alphabetically.

The big-keys keyboards that are commercially available are deficient in that they are incomplete. These keyboards are designed for very small children just learning to read or for adults who, for any number of reasons, need very large keys to operate the computer. Unfortunately, the keys of these known keyboards are simply too big to accommodate the function keys, cursor keys, and numeric keypad. Many individuals who find that standard size keyboards are difficult to use may very well find that existing larger keyboards are simply too big, or that they cannot forego the function keys and numeric keypad.

U.S. Pat. No. 4,244,659, issued Jan. 13, 1981 to Malt, and U.S. Pat. No. 6,005,496, issued Dec. 21, 1999 to Hargreaves et al., show exemplary keyboards having a novel arrangement of keys, including multiple keys positioned for the left and right thumb. The Malt keyboard completely rearranges the keys from the standard QWERTY layout, while Haregreaves et al. maintains the QWERTY layout. Both proposed designs are ergonomic with left and right hand portions separated and a sculptured keyboard shape for easy reach of all the keys. However, they both also have a small, constant-size key for all the letter and number keys, and the keys are substantially equally spaced from each other. Thus, these keys do not accommodate individuals who find standard keyboards difficult to use.

Keyboard overlays are known which modify the shape, size, and number of keys for any number of reasons. U.S. Pat. No. 5,514,855, issued May 7, 1996 to Sullivan, and U.S. patent application Publication 2002/0056612 describe such overlays. Since keyboard overlays typically reduce the number of keys down to a few special purpose keys for playing games, they are not suited to assist people who find standard keyboards difficult to use. Furthermore, they increase the height of the keyboard considerably, which can make using them for extended periods of time uncomfortable.

U.S. patent application Publication 2003/0132916, published Jul. 17, 2003 for Kramer, discloses a multi-purpose keyboard in which the keyboard comprises two parts: a fixed part and a replaceable part. The fixed part includes a sensing grid and platform while the keys themselves are replaceable and can be tailored for a variety of special purposes. Kramer states, “when using the same size of keyboard with fewer keys, the keys may be bigger, and hence easy to operate” (paragraph 67). Kramer does not suggest any specific arrangement or layout of keys other than “bigger”.

U.S. Pat. No. 6,183,149, issued Feb. 6, 2001 to Caplan, describes key top pillows for a computer keyboard to modify the shape of keys and reduce impact to the hand when using a keyboard. This system may reduce incidents of repetitive stress disorders, but it does not truly address the concerns of individuals who find standard keyboards difficult to use due to the size and spacing of the keys.

One problem with standard keyboard layouts and other known layouts is that each letter key and each number key are essentially the same size and placed the same distance apart from each other regardless of how often the key is used or the relative location of the key.

None of the above inventions and patents, taken either singly or in combination, is seen to describe the instant invention as claimed. Thus a computer keyboard solving the aforementioned problems is desired.

### SUMMARY OF THE INVENTION

A computer keyboard comprises a typewriter section containing lettered keys corresponding to letters of an alphabet. Each lettered key is positioned in a standard order but the keys are of non-uniform size.

The advantages of the present invention will become readily apparent upon further review of the following specification and drawings.

### BRIEF DESCRIPTION OF THE DRAWING

The single drawing FIGURE shows a plan view of an exemplary keyboard produced in accordance with the principles disclosed.

### DETAILED DESCRIPTION OF THE PREFERRED EMBODIMENT

The drawing shows an exemplary computer keyboard 10 that is based on QWERTY keyboard layout. The differences between the standard QWERTY keyboard and the presently disclosed one lies in the subtle size differences and spacing differences between the keys.

Keyboard 10 has seven rows of keys. Each key on keyboard 10 belongs to one of the seven rows. The exceptions are the “+” key and the “Enter” keys on numeric keypad 34, which each belong to two rows, as will be further explained below.

Wrist support 28 may be provided for improved ergonomics and may be detachable, as is known.

In addition, each key in rows 16-26 belongs to one of three key groups. The major portion of the keyboard will be referred to as typewriter section 30, and contains all lettered keys, and number, symbol, Tab, Shift, Alt, Ctrl, Enter, and Space keys. Lettered keys are keys that correspond to letters of an alphabet. To the right of typewriter section 30 is cursor key section 32, which includes cursor control keys (up, down, left and right), Insert, Delete, Home, End, Page Up, Page Down, Print Screen, Scroll Lock, and Pause keys. To the right of cursor key section 32 is numeric keypad 34, which comprises a standard numeric keypad. Above numeric keypad 34 are LEDs 36 to provide status as to Num Lock, Caps Lock, and Scroll Lock.

Row 14 is a special row that contains auxiliary multimedia, internet, and miscellaneous buttons. These buttons may be programmable and are generally known in the art.

Rows 18, 20, 22, 24 and 26 contain the standard QWERTY keys and assorted other keys as has become standard for computer keyboards. Also standard and typical is cursor key section 32 and numeric keypad 34. The principles of the disclosed invention are embodied by way of example in row 16 and in typewriter section 30, rows 18-26. Row 16 contains the Esc key and function keys. These keys are evenly spaced apart and extend over cursor control keys 32. Each key in row 16 is 20 mm wide and all are spaced evenly 10 mm apart. There is about 1.5 cm space between rows 16 and 18. The following table defines exemplary spacing in typewriter section 30 for rows 18, 20, 22, 24, and 26:

| ROW/KEY | SIZE | SPACE TO NEXT ROW or KEY |
|---|---|---|
| ROW 18 | 20 mm tall | 5 mm between Rows 18 and 20 |
| \grave{ } | 17 mm wide | 4 mm between \grave{ } and 1 |
| 1 | 17 mm wide | 4 mm between 1 and 2 |
| 2 | 17 mm wide | 4 mm between 2 and 3 |
| 3 | 17 mm wide | 4 mm between 3 and 4 |
| 4 | 17 mm wide | 4 mm between 4 and 5 |
| 5 | 17 mm wide | 4 mm between 5 and 6 |
| 6 | 17 mm wide | 4 mm between 6 and 7 |
| 7 | 17 mm wide | 4 mm between 7 and 8 |
| 8 | 17 mm wide | 4 mm between 8 and 9 |
| 9 | 17 mm wide | 4 mm between 9 and 0 |
| 0 | 17 mm wide | 4 mm between 0 and - |
| - | 17 mm wide | 4 mm between - and = |
| = | 17 mm wide | 4 mm between = and Backspace |
| Backspace | 20 mm wide | |
| Row 20 | 20 mm tall | 5 mm between row 20 and row 22 |
| Tab | 17 mm wide | 4 mm between Tab and Q |
| Q | 17 mm wide | 4 mm between Q and W |
| W | 20 mm wide | 4 mm between W and E |
| E | 25 mm wide | 4 mm between E and R |
| R | 20 mm wide | 4 mm between R and T |
| T | 20 mm wide | 4 mm between T and Y |
| Y | 20 mm wide | 4 mm between Y and U |
| U | 17 mm wide | 4 mm between U and I |
| I | 20 mm wide | 4 mm between I and O |
| O | 17 mm wide | 4 mm between O and P |
| P | 20 mm wide | 4 mm between P and [ |
| [ | 15 mm wide | 4 mm between [ and ] |
| ] | 15 mm wide | 4 mm between ] and \ |
| \ | 13 mm wide | |
| ROW 22 | 20 mm tall | 5 mm between row 22 and row 24 |
| Capslock | 17 mm wide | 4 mm between Capslock and A |
| A | 20 mm wide | 10 mm between A and S |
| S | 20 mm wide | 5 mm between S and D |
| D | 20 mm wide | 5 mm between D and F |
| F | 20 mm wide | 2 mm between F and G |
| G | 17 mm wide | 4 mm between G and H |
| H | 17 mm wide | 4 mm between H and J |
| J | 17 mm wide | 4 mm between J and K |
| K | 20 mm wide | 5 mm between K and L |
| L | 20 mm wide | 5 mm between L and ; |
| ; | 20 mm wide | 4 mm between ; and ' |
| ' | 17 mm wide | 0 mm between ' and Enter |
| Enter | 29 mm wide | |
| ROW 24 | 20 mm tall | 2 mm between row 24 and row 26 |
| Shift | 20 mm wide | 4 mm between Shift and Z |
| Z | 1.7 mm wide | 4 mm between Z and X |
| X | 20 mm wide | 5 mm between X and C |
| C | 20 mm wide | 5 mm between C and V |
| V | 20 mm wide | 5 mm between V and B |
| B | 20 mm wide | 5 mm between B and N |
| N | 20 mm wide | 5 mm between N and M |
| M | 20 mm wide | 5 mm between M and , |
| , | 20 mm wide | 5 mm between , and . |
| . | 20 mm wide | 5 mm between . and / |
| / | 17 mm wide | 4 mm between / and Shift |
| Shift | 36 mm wide | |
| ROW 26 | 20 mm tall | 2 mm between row 24 and row 26 |
| Ctrl | 20 mm wide | 15 mm between Ctrl and Alt |
| Alt | 20 mm wide | 15 mm between Alt and Space |
| Space | 170 mm wide | 10 mm between Space and Alt |
| Alt | 20 mm wide | 15 mm between Alt and Ctrl |
| Ctrl | 20 mm wide | |

As can be seen from the exemplary keyboard layout, some keys are wider than others, and the key spacing is non-uniform. The size of each key and its spacing is based on two major factors: the position on the keyboard and the anticipated frequency of key usage. With regard to the position, keys that, based on common touch-typing rules, are used by the most dexterous fingers are smaller and closer to its neighbors, while keys that are used by less dexterous fingers are larger and farther apart.

Thus, keys situated near the center of typewriter section 30 and used by the index and middle finger are smaller and closer together than keys positioned toward the left and right sides of typewriter section 30. Keys positioned on the right side of the keyboard, e.g., the “J” key, tend to be smaller than keys situated similarly but on the left side, e.g., the “F” key because most people are right-handed and are more dexterous in their right hand than in their left hand. A left-handed and ambidextrous versions of computer keyboard 10 are contemplated, in which the left hand keys tend to be smaller and closer together or equally sized and spaced, respectively.

With regard to anticipated frequency of key usage, keys that tend to be used more often, e.g., the “E” key, and the “Enter” key are larger than keys used less often, e.g., the “Z” and “Q” keys.

It should be noted that the exemplary keyboard described above is somewhat larger than the standard keyboard. For example, the width of typewriter section 30 is 300 mm while the typewriter section of a standard computer keyboard is 280 mm. The distance from the left side of the “A” key to the right side of the “;” key is 252 mm whereas the same distance for a standard computer keyboard is about 205 mm. If desired, the left most and right most keys on each row in typewriter section 30 may be widened for larger Tab, Backspace, Capslock, Enter, Shift, and Ctrl keys.

Cursor key section 32 and numeric keypad 34 have, in general, uniform spacing and sizing of keys. For example, each key in cursor key section 32 may be 20 mm wide with 5 mm spacing while each key in numeric keypad 34 may be 17 mm wide with 4 mm spacing. On numeric keypad 34, the “+” key is 45 mm tall and extends across rows 20 and 22 while the “Enter” key is 35 mm tall and extends across rows 24 and 26.

The increased size makes keyboard 10 much easier for individuals with large hands or who find themselves constantly hitting two keys at once.

These principles can be applied to any keyboard layout, including non-English keyboard layouts and alternatives to QWERTY, such as Dvorak. In addition, it should be recognized that the numeric keypad section is optional and may be incorporated into the typewriter section as is generally known in the art through the use of an auxiliary function key. It is envisioned that a standard keyboard width can be maintained by so integrating the numeric keypad with the typewriter section.

It should therefore be understood that the present invention is not limited to the embodiment described above, but encompasses any and all embodiments within the scope of the following claims.

1. A computer keyboard, comprising:
a typewriter section containing lettered keys corresponding to letters of an alphabet, each lettered key being positioned in a standard order, said keys being of non-uniform size with respect to one another.

2. The computer keyboard according to claim 1, wherein said lettered keys are sized such that a subset of said lettered keys positioned toward the center of the typewriter section are smaller than a remaining set of lettered keys positioned toward either side of the typewriter section.

3. The computer keyboard according to claim 2 wherein a second subset of said lettered keys positioned for use by the right hand are smaller than corresponding lettered keys that are positioned similarly for use by the left hand.

4. The computer keyboard of claim 1 wherein said lettered keys are sized such that a subset of said lettered keys corresponding to letters having a high frequency of usage are larger than a remaining set of lettered keys corresponding to letters having a lower frequency of usage.

5. The computer keyboard of claim 1 wherein said lettered keys are spaced from each other in a non-uniform manner.

6. The computer keyboard according to claim 5, wherein said lettered keys are spaced such that a subset of said lettered keys positioned toward the center of the typewriter section are closer together than a remaining set of lettered keys positioned toward either side of the typewriter section.

7. The computer keyboard according to claim 6 wherein a second subset of said lettered keys positioned for use by the right hand are spaced closer together than corresponding lettered keys that are similarly positioned for use by the left hand.

8. The computer keyboard of claim 5 wherein said lettered keys are sized such that a subset of said lettered keys corresponding to letters having a high frequency of usage are spaced farther apart than a remaining set of lettered keys corresponding to letters having a lower frequency of usage.

9. The computer keyboard of claim 1 wherein said lettered keys have a minimum width of about 17 mm.

10. The computer keyboard of claim 9 wherein said lettered keys have a maximum width of about 25 mm.

11. The computer keyboard of claim 9 wherein said lettered keys are about 20 mm tall and rows of said lettered keys are spaced apart by about 5 mm.
